(19) United States
(12) Patent Application Publication
(10) Pub. No.: US 2026/0070581 A1
(43) Pub. Date: Mar. 12, 2026

(54) METHOD OF CONTROLLING AUTONOMOUS DRIVING AND VEHICLE

(71) Applicants: Hyundai Motor Company, Seoul (KR); Kia Corporation, Seoul (KR)

(72) Inventor: Dong Hoon KANG, Hwaseong-Si (KR)

(73) Assignees: Hyundai Motor Company, Seoul (KR); Kia Corporation, Seoul (KR)

(21) Appl. No.: 19/320,394

(22) Filed: Sep. 5, 2025

(30) Foreign Application Priority Data
Sep. 12, 2024 (KR) 10-2024-0124563

(51) Int. Cl. B60W 60/00; B60Q 1/34; B60W 30/14; B60W 30/18

(52) U.S. Cl. CPC B60W 60/001; B60Q 1/346; B60W 30/146; B60W 30/18154; B60W 2520/10; B60W 2540/30; B60W 2552/05; B60W 2554/4041; B60W 2556/10; B60W 2720/10

(57) ABSTRACT

A method for controlling autonomous driving and a vehicle, includes generating speed information for driving control of the vehicle at a roundabout based on driving setting information of a user related to the roundabout; generating driving control information based on the speed information; and controlling an operation indicator of a vehicle in an area including a place of the roundabout determined by a route of the vehicle and controlling a driving of the vehicle at the roundabout according to the driving control information. The driving setting information is generated in response to a mode selected from a designated mode and a driving pattern mode by the user.

### CROSS-REFERENCE TO RELATED APPLICATION

The present application claims priority to and the benefit of Korean Patent Application No. 10-2024-0124563, filed on Sep. 12, 2024, the disclosure of which is incorporated herein by reference in its entirety.

### BACKGROUND

### Field of the Present Disclosure

The present disclosure relates to a method for controlling autonomous driving and a vehicle, and more specifically, to a method for controlling autonomous driving to prevent driving discomfort at a roundabout and improve stability by reflecting a user's driving pattern to control autonomous driving at the roundabout, and a vehicle.

### Discussion of Related Art

Recently, vehicles have been commercialized with an autonomous driving function for driving convenience. The autonomous driving function is being developed to realize fully autonomous driving in which a vehicle has the full driving control authority without driver intervention in any situation. Before the release of fully autonomous driving, some functions of the full autonomous driving are being installed and used in commercialized vehicles.

An autonomous driving-based vehicle may detect a surrounding environment obtained by sensors, obtain various types of data from the inside and the outside of the vehicle, identify situations around the vehicle based on the detected surrounding environment and data, establish an autonomous driving strategy or control plan corresponding to the identified situations, and control actuators of the vehicle for driving according to the above strategy.

In autonomous driving, an operational design domain (ODD) according to the level is required. The ODD may define an environmental scope and conditions in which autonomous driving is operated, executed, and applied. The ODD of a specific level or more is applied up to the downtown, and items related to a roundabout are included in the scope of an autonomous driving control target. To deal with the roundabout, vehicles use a pre-deceleration strategy to pass the roundabout, but a deceleration strategy that considers an actual driver's driving habit is not achieved because the amount of deceleration is set and fixed.

When an autonomous driving function such as an advanced driver assistance system (ADAS) is performed at a roundabout, the behavior of autonomous driving is not similar to the user's actual driving style, and thus a case in which the user deactivates the autonomous driving function occurs frequently. Specifically, since the user feels anxious due to driving discomfort, the user may frequently deactivate autonomous driving and switch the autonomous driving to manual driving.

Furthermore, due to the features of the roundabout, vehicles may enter in various directions, and thus the driving control at the roundabout cannot be properly processed by relying on the conventional speed maintenance or deceleration strategy.

### SUMMARY OF THE INVENTION

The present disclosure is directed to providing a method for controlling autonomous driving to prevent driving discomfort at a roundabout and improve stability by reflecting a user's driving pattern to control autonomous driving at the roundabout, and a vehicle.

The objects of the present disclosure are not limited to the above-described object, and other objects that are not described will be able to be clearly understood by those skilled in the art to which the present disclosure pertains from the following description.

According to the present disclosure, there is provided a method for controlling autonomous driving, the method including: generating speed information for driving control of the vehicle at a roundabout based on driving setting information of a user related to the roundabout; generating driving control information based on the speed information; and controlling an operation indicator of a vehicle in an area including a place of the roundabout determined by a route of the vehicle and controlling a driving of the vehicle at the roundabout according to the driving control information. The driving setting information is generated in response to a mode selected from a designated mode and a driving pattern mode by the user.

According to the exemplary embodiment of the present disclosure in the method, one of a required speed of the user at the roundabout and a first reduction level for a target speed of a road other than the roundabout may be set in the designated mode, and a speed determined based on driving pattern information of the user at the roundabout may be set in the driving pattern mode.

According to the exemplary embodiment of the present disclosure in the method, the driving pattern information may be provided based on manual driving of the user at one or more roundabouts or driving data according to past driving setting information of the user, and a reference number or more of pieces of the driving data may be accumulated and collected as data for the driving at a speed limit or less at the roundabout.

According to the exemplary embodiment of the present disclosure in the method, a speed according to a second reduction level of the target speed determined based on the driving pattern information may be set in the driving pattern mode, and a reduction ratio for the target speed applied to the second reduction level may be provided differently from a reduction ratio of the target speed at the first reduction level.

According to the exemplary embodiment of the present disclosure in the method, the generating of the speed information may include generating the speed information based on driving route information of the vehicle, a target speed of a driving road before entering the roundabout, and a speed limit at the roundabout in addition to the driving setting information.

According to the exemplary embodiment of the present disclosure in the method, the method further may comprise, before the controlling of the operation indicator and the controlling of the driving, performing yield control of the vehicle at an entry point when the vehicle reaches the area including the entry point of the roundabout and detecting that another vehicle travels in a section of the roundabout that falls within a predetermined range from the entry point.

According to the exemplary embodiment of the present disclosure in the method, the generating of the driving control information may include generating the driving control information based on preceding vehicle information detected from a preceding vehicle that travels at the roundabout in addition to the speed information.

According to the exemplary embodiment of the present disclosure in the method, the operation indicator includes a turn signal lamp. The controlling of the operation indicator of the vehicle includes: turning the turn signal lamp on before an entry point of the roundabout; and turning the turn signal lamp off in response to detection that both rear wheels of the vehicle enter a main lane section of the roundabout.

According to the exemplary embodiment of the present disclosure in the method, the operation indicator includes a turn signal lamp. The controlling of the operation indicator of the vehicle includes: turning the turn signal lamp on before an exit point of the roundabout; and turning the turn signal lamp off in response to detection that both rear wheels of the vehicle exit the exit point.

According to the exemplary embodiment of the present disclosure in the method, the method may comprise, after the controlling of the operation indicator and the controlling of the driving, controlling the driving of the vehicle based on a target speed applied at a road subsequently connected to the roundabout in response to the exit of the vehicle from the roundabout.

According to another embodiment of the present disclosure, there is provided a vehicle, the vehicle including: a sensor unit configured to detect a surrounding environment of the vehicle; a memory configured to store at least one instruction controlling the vehicle; and a processor operatively connected to the sensor unit and the memory and configured to execute the at least one instruction stored in the memory. The processor is configured to: generate speed information for driving control of the vehicle at a roundabout based on driving setting information of a user related to the roundabout; generate driving control information based on the speed information; and control an operation indicator of the vehicle in an area including a place of the roundabout determined by a route of the vehicle and control a driving of the vehicle at the roundabout according to the driving control information. The driving setting information is generated in response to a mode selected from a designated mode and a driving pattern mode by the user.

The features briefly summarized above for the present disclosure are only exemplary aspects of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view showing a vehicle that communicates with other devices to transmit and receive data;

FIG. 2 is a view showing modules constituting a vehicle according to one embodiment of the present disclosure;

FIG. 3 is a flowchart of a method for controlling autonomous driving according to another embodiment of the present disclosure;

FIG. 4 is a view showing a roundabout on which a vehicle travels;

FIG. 5 is a view showing the acquisition of driving pattern information of a vehicle user;

FIG. 6 is a flowchart of a process of controlling a turn signal lamp to turn on or off, which is implemented in an entry situation into a roundabout; and

FIG. 7 is a flowchart of a process of controlling a turn signal lamp to turn on or off, which is implemented in a situation in which a vehicle exits a roundabout.

### DETAILED DESCRIPTION OF EXEMPLARY EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the exemplary embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an exemplary embodiment of the present disclosure could be termed a second element in another embodiment, and similarly, a second element in an exemplary embodiment of the present disclosure could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an exemplary embodiment of the present disclosure composed of a subset of elements described in an exemplary embodiment of the present disclosure is also included in the scope of the present disclosure. Furthermore, embodiments including other elements in addition to the elements described in the various embodiments are also included in the scope of the present disclosure.

The advantages and features of the present disclosure and the way of attaining them will become apparent with reference to exemplary embodiments described below in detail in conjunction with the accompanying drawings. Embodiments, however, may be embodied in many different forms and should not be constructed as being limited to example embodiments set forth herein. Rather, these embodiments are provided so that the present disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

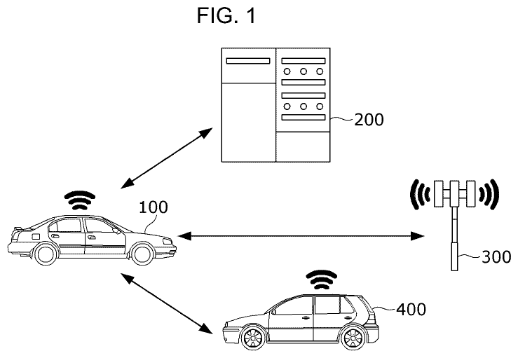

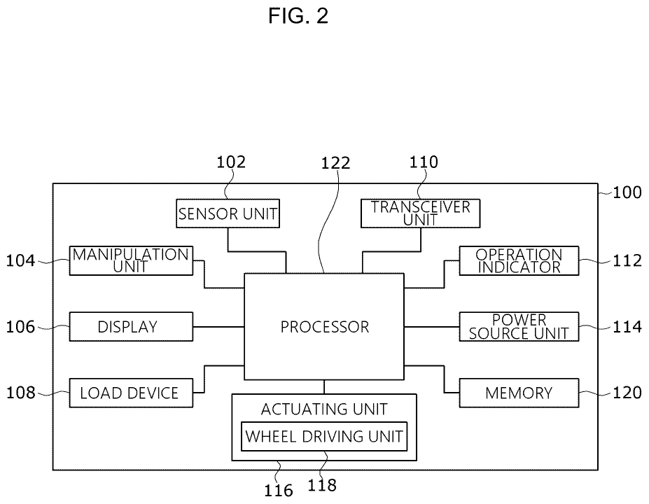

Hereinafter, a vehicle which is adaptively controlled according to a user's request or intention depending on a road type and has at least some of autonomous driving functions will be described with reference to FIGS. 1 and 2. FIG. 1 is a view showing a vehicle that communicates with other devices to transmit and receive data.

Referring to FIG. 1, a vehicle 100 may be driven based on electrical energy or fossil energy. In the case of electrical energy, the vehicle 100 may be, for example, a pure battery-based vehicle driven by only a high-voltage battery or may adopt a gas-based fuel cell as an energy source. Furthermore, a fuel cell may use any form of gas that may generate electrical energy, and the gas may be charged to the vehicle 100, for example, in a liquefied state. Here, the gas may be, for example, hydrogen. However, the present disclosure is not limited thereto, and any gas may be applied. In the case of fossil energy, the vehicle 100 may be driven based on fuel such as gasoline, diesel, or liquefied gas and provided with an internal combustion engine that drives an actuating unit 116 by combustion of the fuel. The engine may be included in a power source unit 114 from the perspective of providing a driving rotation force of a wheel to a wheel driving unit 118. As an exemplary embodiment of the present disclosure, the vehicle 100 may drive the actuating unit 116 by selectively using an internal combustion engine based on fossil energy and the energy of an electric battery and may be a hybrid-type vehicle.

The vehicle 100 may be a movable device. The vehicle 100 is a ground vehicle that travels on the ground and may be a typical passenger or commercial vehicle, a purpose built vehicle (PBV), etc. The vehicle 100 may be a four-wheeled vehicle, for example, a passenger vehicle, an SUV, a small truck, or a vehicle with more than four wheels, for example, a bus, a large truck, a container transport vehicle, a heavy equipment vehicle, etc. The vehicle 100 may be a robot in a broad sense, such as a means of transportation, and the robot may be moved using wheels, caterpillar, or other moving modules.

The vehicle 100 may travel under autonomous driving control, and autonomous driving may be implemented as semi-autonomous driving or full autonomous driving. The full autonomous driving may be provided as autonomous movement in which a processor 122 of the vehicle 100 has full control authority without user intervention even in an uncertain driving situation. The semi-autonomous driving may provide autonomous movement that requires driver intervention depending on a specific driving situation. The semi-autonomous driving may be implemented by allowing a user to perform manual driving by transferring control authority to the user after autonomous driving is deactivated according to situations. According to the level of the autonomous driving defined by the Society of Automotive Engineers (SAE), the semi-autonomous driving corresponds to autonomous driving levels 1, 2, 3 and 4, and fully autonomous driving corresponds to level 5.

Meanwhile, the vehicle 100 may communicate with other devices 200 and 300 or another vehicle 400. The other devices may include, for example, a server 200 for supporting various control, state management, and driving of the vehicle 100, an intelligent transportation system (ITS) device 300 for receiving information from an ITS, various types of user devices, etc. The server 200 may be, for example, an external device operated by a vehicle manufacturer or provided to service autonomous driving and may receive connected data of the vehicle 100 or transmit data required for autonomous driving. To support autonomous driving and various services of the vehicle 100, the server 200 may transmit various types of information and software modules that are used for controlling the vehicle 100 to the vehicle 100 in response to the requests and data transmitted from the vehicle 100 and the user device.

The ITS device 300 is a type of an external device and may be, for example, a road side unit (RSU). The ITS device 300 may exchange vehicle detection data, driving control and state data, environmental data around a vehicle, map data, etc. with the vehicle 100 through vehicle to infrastructure (V2I) to assist the user's driving or support the autonomous driving of the vehicle 100. The vehicle 100 may exchange the data listed above with another vehicle 400 through vehicle to vehicle (V2V) to support manual driving or autonomous driving.

The vehicle 100 may communicate with another vehicle or other devices based on cellular communication, wireless access in vehicular environment (WAVE) communication, dedicated short range communication (DSRC), short-range communication, or another communication method.

For example, the vehicle 100 may use a communication network such as Long Term Evolution (LTE) or 5G, WiFi communication network, WAVE communication network, etc. As a cellular communication network to communicate with the server 200, the ITS device 300, and another vehicle 400. As an exemplary embodiment of the present disclosure, the DSRC, etc. used in the vehicle 100 may be used for communication between vehicles. A communication method between the vehicle 100, the server 200, the ITS device 300, another vehicle 400, and the user device is not limited to the above-described embodiment.

FIG. 2 is a view showing a module constituting a vehicle according to one embodiment of the present disclosure.

The vehicle 100 may include a sensor unit 102, a manipulation unit 104, a display 106, a load device 108, and a transceiver unit 110.

The sensor unit 102 may include various types of detectors for detecting various states and situations that occur in an external environment, an internal system, a user manipulation, and a boarding space of the vehicle 100. The sensor unit 102 may be referred to as a sensor, which is a general term for a sensor module provided in the sensor unit 102. The sensor unit 102 may include an outer-facing camera, a light detection and ranging (LiDAR) sensor, a radio detection and ranging (RADAR) sensor, etc. to detect dynamic and static objects that are present outside the vehicle 100. The sensor unit 102 may include a positioning sensor, a wheel sensor, an attitude sensor, etc. To check its own position, speed, and driving attitude. Therefore, a detection module for detecting various situations not listed may be additionally included in the sensor unit 102.

The manipulation unit 104 may be a module which is manipulated for a user's driving. For example, the manipulation unit 104 may be a steering wheel for manual driving, a turn indicator that notifies a turning direction to nearby objects, a direction automatic or manual shift actuator, an accelerator pedal, a brake pedal, a transmission, etc. Here, the nearby objects may be, for example, nearby vehicles or pedestrians. The turn indicator may be provided in hardware, such as a lever or a button, or disposed as a user interface, such as a soft key.

Furthermore, the manipulation unit 104 may further include an interface for using, deactivating, and selecting detailed functions of an autonomous driving mode requested by the user so that the user may use the autonomous driving function. To receive various requests related to autonomous driving, the manipulation unit 104 may be composed of, for example, a hard type interface provided at a predetermined position inside the vehicle 100 or a soft type interface which may be touched on the display 106.

The display 106 is configured as a user interface. The display 106 may output and display, by the processor 122, the operation state, control state, route/traffic information, remaining energy information (e.g., remaining power information such as remaining fuel information, remaining charge information, etc.), content requested by a driver, etc. of the vehicle 100. Furthermore, the display 106 may be a touch screen configured for detecting a driver input and may receive the driver's request that instructs the processor 122.

The load device 108 may be mounted on the vehicle 100 and may be a type of non-driving electric device excluding a driving power system such as the wheel driving unit 118. The load device 108 is an auxiliary device for receiving power from the power source unit 114 and may be, for example, various devices provided in an air conditioning system, a lighting system, a seat system, and the vehicle 100.

The transceiver unit 110 may support mutual communication with the server 200, ITS device 300, the nearby vehicle 300, etc. The transceiver unit 110 may include, for example, a module for processing cellular communication, WAVE, DSRC communication, etc. In an exemplary embodiment of the present disclosure, the transceiver unit 110 may transmit data generated or stored while driving to the server 200 and receive data and software module transmitted from the server 200. The transceiver unit 110 may support communication with electronic devices carried by passengers inside the vehicle 100. In an exemplary embodiment of the present disclosure, the vehicle 100 may transmit and receive data used in the method according to an exemplary embodiment of the present disclosure with an external device through the transceiver unit 110.

Furthermore, the vehicle 100 may include an operation indicator 112, the power source unit 114, and the actuating unit 116.

The operation indicator 112 may be an indicating device for providing a driving operation state or future driving behavior to nearby objects and/or users. Furthermore, the operation indicator 112 may be a device for notifying the nearby objects and/or users of the operation state performed by the user on the manipulation unit 104 while driving.

The operation indicator 112 may include, for example, a brake lamp for notifying nearby objects of the user's manipulation of the brake pedal or a braking operation generated by the processor 122 that performs autonomous braking.

Furthermore, the operation indicator 112 may include a turn signal lamp for notifying of a left or right turn which is scheduled by the user's manipulation of a turn indicator or a processor that performs autonomous turning control. The turn signal lamp may include an external turn signal lamp mounted outside a vehicle body to notify nearby objects and an internal turn signal lamp provided on a dashboard or the display 106 for user recognition. The internal turn signal lamp may be configured in hardware such as a light source module, or may be implemented in software such as a specific icon displayed on the display 106. The turn signal lamp related to the exemplary embodiment of the present disclosure may be an external turn signal lamp, and in an exemplary embodiment of the present disclosure, the external turn signal lamp may be described by being interchangeably used with the turn signal lamp unless contradicted in the description.

Furthermore, the operation indicator 112 is exemplified as a brake lamp and a turn signal lamp in relation to the present disclosure, but is not limited thereto, and may include indicating devices including various functions.

The power source unit 114 may be configured to generate and supply power and electric power that are used in a driving power system and a non-driving power system, such as the actuating unit 116. The non-driving power system may be, for example, the sensor unit 102, the manipulation unit 104, the display 106, the load device 108, the transceiver unit 110, and the operation indicator 112. The non-driving power system is not limited thereto and may include various components that implement detecting, interface, communication, and convenience functions other than components directly involved in the driving operation. When the vehicle 100 is driven based on electrical energy, the power source unit 114 may be, for example, an electric battery which is charged from the outside thereof or a combination of an electric battery and a fuel cell that charges the battery. In the case of a combination of the electric battery and the fuel cell, the power source unit 114 may include a tank that stores a material used to produce power for the fuel cell, for example, liquefied hydrogen. When the vehicle 100 is driven based on fossil energy, the power source unit 114 may be an internal combustion engine. Furthermore, when the vehicle 100 is a hybrid type, the power source unit 114 may be provided as a combination of the internal combustion engine and the electric battery.

The actuating unit 116 may include at least one module that implements a driving operation and may perform at least one driving operation of longitudinal control such as acceleration and deceleration and lateral control such as steering according to a user request from the manipulation unit 104. To perform the driving operation according to the user's manual manipulation or the instruction of the processor 122 by autonomous driving, the actuating unit 116 may include the wheel driving unit 118, and a mechanical component and electronic module for implementing the driving operation of the wheel driving unit 118. When the vehicle 100 is operated based on electrical energy, the vehicle 100 may include an assembly for transmitting the requested driving operation to the wheel driving unit 118. When the vehicle 100 is operated based on fossil energy, the actuating unit 116 may include a transmission and a gear module for transmitting the power of an internal combustion engine.

The wheel driving unit 118 may include a plurality of wheels, a driving force generation module for generating and applying a driving force to wheels or transmitting the driving force, a braking module for decelerating the driving of the wheels, a steering module for achieving transverse control of the wheels. When the vehicle 100 is driven based on electrical energy, the driving force generation module may be a motor assembly for generating a driving force based on power output from the electric battery. The braking module of the electricity-based vehicle 100 may further include a regenerative braking function.

Furthermore, the vehicle 100 may include a memory 120 and a processor 122.

The memory 120 may store applications and various types of data for controlling the vehicle 100 and load the applications or read or write data at the request of the processor 122. In an exemplary embodiment of the present disclosure, the memory 120 may store an application and at least one instruction for controlling autonomous driving at a roundabout. Furthermore, the memory 120 may store or manage the applications and various types of information and data required for the instruction.

For example, the memory 120 may store map information and traffic information to establish a route to a destination requested by a user through a navigation device provided on the display 106. The map information may include road types, road structures, road restriction information, traffic sign information, and the like and may be a low-precision map at the road level and/or a high-precision map at the lane level. The traffic information may include, for example, traffic conditions on the road, accident information, weather information on the road, etc. The map information and traffic information may be stored in the server 200, and the server 200 may transmit map information and traffic information that are related to a route established by a user request to the vehicle 100 so that the memory 120 may manage related information, that is, the map information and traffic information.

Furthermore, the memory 120 may manage vehicle data generated while driving. The vehicle data may include, for example, a longitudinal control state of the vehicle 100, a transverse control state, driving data, surrounding environment data obtained by the sensor unit 102, and data on autonomous driving control. The longitudinal control state may have, for example, a driving speed, acceleration, etc. The transverse control state may include, for example, a rotation angle of a steering wheel, a rotation angular speed of the steering wheel, etc. The longitudinal control state and the transverse control state may be, for example, obtained by use of or analyzing Controller Area Network (CAN) data generated while driving by an electric power unit (EPU) that forms the sensor unit 102 and the processor 122.

The driving data including longitudinal control states and transverse control states accumulated according to the user's manual driving may be accumulated and stored. The data on autonomous driving control may include, for example, speed information based on a user's driving setting information related to a roundabout and a user's target speed for a road other than the roundabout. When the driving setting information is generated using driving pattern information that estimates a user's driving habit or intention based on the driving data, the data on autonomous driving control may manage the driving pattern information.

The processor 122 may perform the overall control of the vehicle 100. The processor 122 may be configured to execute applications and instructions that are stored in the memory 120.

Regarding the present disclosure, the processor 122 may perform processing for generating speed information for driving control of the vehicle at a roundabout based on the driving setting information related to a roundabout of the user. The processor 122 may execute processing for generating driving control information based on the speed information. Furthermore, the processor 122 may implement processing for controlling an operation indicator of the vehicle in an area including a place of the roundabout determined by a route of the vehicle. The processor 122 may perform processing for controlling the driving of the vehicle 100 at the roundabout according to the driving control information.

In an exemplary embodiment of the present disclosure, the processor 122 is shown as a single processing module configured to execute the above-described processing. In another example, the processor 122 may be composed of a plurality of processing modules, and the processing may be performed in a distributed manner in the plurality of modules.

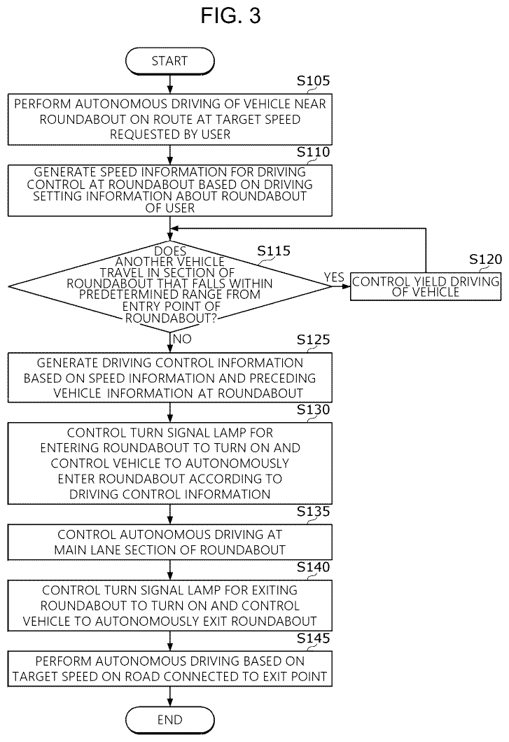

The above-described processing of the processor 122 will be described in detail with reference to FIGS. 3 to 7.

Hereinafter, a method for controlling autonomous driving according to an exemplary embodiment of the present disclosure will be described with reference to FIGS. 3 to 7. FIG. 3 is a flowchart of a method for controlling autonomous driving according to another embodiment of the present disclosure. In an exemplary embodiment of the present disclosure, an example in which the vehicle 100 adopts autonomous driving that reflects a user's driving pattern or intention at a roundabout will be described. The exemplary embodiment of the present disclosure may be practically applied to a specific type of road other than a highway and a straight road. Furthermore, the processor 122 performing the method according to an exemplary embodiment of the present disclosure may be described by being interchangeably used with the vehicle 100 for convenience of description.

First, the vehicle 100 may move autonomously along a route to a destination at a target speed requested by a user by the processor 122, and the processor 122 may identify that the vehicle 100 has reached near a roundabout on the route (S105).

The route may be, for example, a global route to a destination designated by the user through a navigation device provided on the display 106.

The target speed is a speed of autonomous driving applied at a road connected to enter a roundabout and may be set by the user. For example, when the user requests constant-speed autonomous driving, lane-keeping driving, and full autonomous driving that are adaptive to traffic conditions and road types, the user may set the target speed at the same time as the above request. The target speed may be changed by the user's adjustment or re-setting even after the setting.

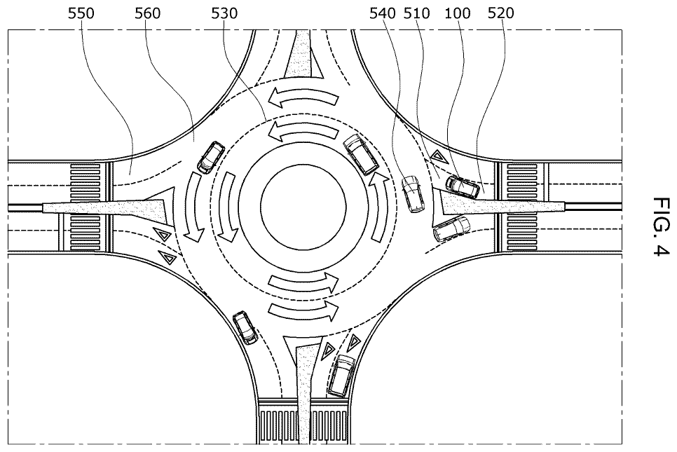

The road related to the target speed may be a general road rather than a special type of road such as a roundabout, such as a straight road, a road including a curved section with a predetermined curvature, a road extending from a general intersection at which vehicles pass while crossing each other, etc. FIG. 4 shows that a road to which the target speed is applied is a road including a plurality of lanes and extending in a substantially straight lane. FIG. 4 is a view showing a roundabout on which a vehicle travels.

Meanwhile, based on position data of a positioning sensor, surrounding environment data obtained by a camera and a LiDAR sensor, and map information, the processor 122 may identify whether the vehicle 100 has reached a place on a road near to a roundabout. The processor 122 may detect the existence and position of the roundabout on the route and check whether the vehicle 100 has reached a place on the road in front of the roundabout on the route. The place on the road may be, for example, an area of the road positioned at a predetermined distance from the roundabout or an area in which a road sign related to the roundabout is present. The place on the road may be identified using the data obtained from the above-described sensor and the map information. Furthermore, the determination of whether the vehicle 100 has passed or reached the place may be processed using the data obtained from the above-described sensor.

When the vehicle 100 reaches the place on the road near to the roundabout, the processor 122 may be configured to generate speed information for driving control at the roundabout based on the user's driving setting information related to the roundabout (S110).

The driving setting information may be detailed control information applied to autonomous driving by a user or a processor. For example, the user may select an option from the function setting of autonomous driving provided on the manipulation unit 104 or the display 106. The driving setting information may include detailed control of autonomous driving designated for various driving environments and for each road type. The user may request the vehicle 100 to perform autonomous driving (e.g., smart cruise control (SCC)) on a general road other than a roundabout and set a target speed for the general road. This may be an example in which the user inputs driving setting information simultaneously with the activation of an autonomous function during driving. As an exemplary embodiment of the present disclosure, the user may set the driving setting information in advance before activation of the autonomous function. The driving setting information for autonomous driving on a specific type of road, such as a roundabout, may be set in advance. The roundabout may typically be connected to a general road. In a case in which the user activates the autonomous function while driving along at least some routes for the destination, when the vehicle 100 requests driving setting information from the user while entering the roundabout from the general road, manipulation convenience and driving stability may be lowered. However, when the vehicle travels at the roundabout or approaches the roundabout to enter, driving setting information for the roundabout may be designated by the user's request or the user's response to a query of the processor 122.

In an exemplary embodiment of the present disclosure, the content of the driving setting information is described as being related to a special type of road, such as a roundabout, but the content may be similarly applied to other special types of roads other than the general road.

The driving setting information may be generated in response to a mode selected from a designated mode and a driving pattern mode by the user.

First, the designated mode may be, for example, a type which is set to a user's requested speed at a roundabout. As an exemplary embodiment of the present disclosure, one of a first reduction level for the target speed on a road other than a roundabout may be set in the designated mode. Here, the road may be a road of the type listed as the above-described general road. The designated mode of the present example may provide the user with a plurality of speed levels as the first reduction level which is lower than the target speed. The speed level may have, for example, options classified into low, normal, and high speeds, is not limited thereto, and may be constructed in various ways. For example, in order for all speed levels for the above-described option to include a lower speed than the target speed, the low speed level may be defined as a speed corresponding to a 30% deceleration rate of the target speed, the normal speed level may be defined as a speed corresponding to a 20% deceleration rate of the target speed, and the high speed level may be defined as a speed corresponding to a 10% deceleration rate of the target speed. This is not limited to the above-described specific examples, and the deceleration rate of each level may be provided in various ways as long as the speed is lower than the target speed.

A speed which is determined based on the user's driving pattern information at a roundabout may be set in the driving pattern mode according to the driving setting information. The driving pattern information may be provided based on the user's manual driving at one or more roundabouts or driving data according to past driving setting information. The driving data may be one piece of vehicle data or may be generated from detailed data constituting the vehicle data. The driving data including longitudinal control states and transverse control states accumulated according to a user's manual driving may be accumulated and stored. The longitudinal control state may have, for example, a driving speed, acceleration, etc. The transverse control state may include, for example, a rotation angle of a steering wheel, a rotation angular speed of the steering wheel, etc. The longitudinal control state and the transverse control state may be, for example, obtained by use of or analyzing CAN data generated while driving by the EPU that constitutes the sensor unit 102 and the processor 122.

In an exemplary embodiment of the present disclosure, the driving data may be exemplified as a driving speed and acceleration related to the roundabout at which the user has driven in the past or has driven using driving setting information selected in the past. Depending on the data type required for generating the driving setting information, the driving data may adopt various types of data listed in the longitudinal control state and the transverse control state. The driving data related to the roundabout may be a series of data from a road within a predetermined distance range before entering the roundabout to a road within a predetermined distance range after exiting the roundabout.

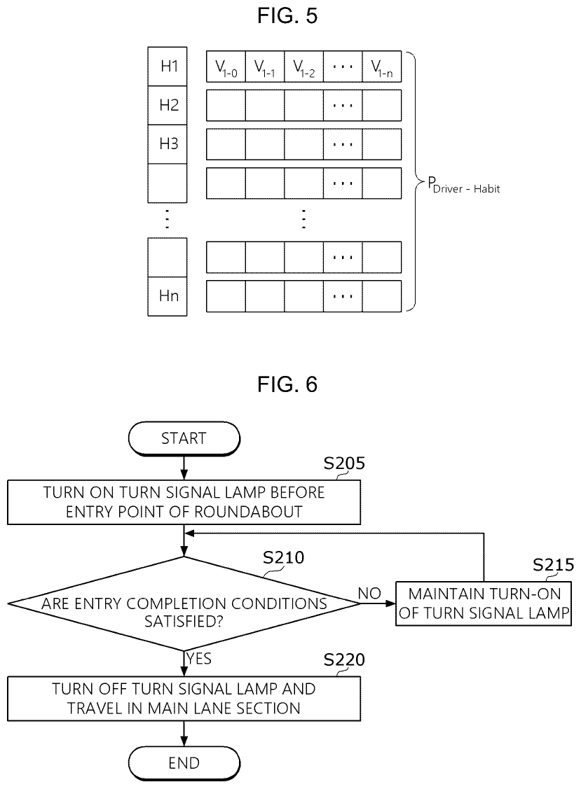

Driving pattern information P_{Driver-Habit} for generating driving setting information may be generated using a reference number or more of pieces of past accumulated driving data at a speed limit or less at a roundabout as shown in FIG. 5. FIG. 5 is a view showing the acquisition of driving pattern information of a vehicle user. The processor 122 may use driving data accumulated at one or more roundabouts on which the user has already driven regardless of a roundabout on a current route. The processor 122 may exclude driving data in which a driving speed manually driven at the roundabout exceeds the speed limit from the accumulated driving data. Referring to FIG. 5, the processor 122 may verify whether a driving data set H1, H2, H3 . . . , or Hn for each roundabout in which the user has driven in the past is the speed limit or less at each roundabout and may also check whether the number of accumulated data sets is the reference number or more. When the above conditions are satisfied, the processor 122 may, for example, generate driving pattern information P_{Driver-Habit} by statistics or machine learning for the plurality of driving data sets.

A speed according to a second reduction level of a target speed determined based on driving pattern information may be set in the driving pattern mode. The driving pattern mode of the present example may provide a plurality of individualized speed levels as the second reduction level which is lower than the target speed. The individualized speed level may be, for example, classified into low, normal, and high speeds, is not limited thereto, and may be constructed in various ways. Furthermore, the processor 122 may select one of the speed levels (low, normal, or high speed) that substantially matches the driving speed according to the driving pattern information and may be configured to determine that the selected speed level is a speed of the driving pattern mode.

A reduction ratio of the target speed to which the second reduction level for the individualized speed level is applied may be set differently from a reduction ratio of the target speed at the first reduction level. For example, when it is analyzed that the user drives at the roundabout at a speed faster than the speed according to the first reduction level based on the driving pattern information, the reduction ratio of the second reduction level may be set to be smaller than the reduction ratio of the first reduction level. For example, in order for all individualized speed levels to include a lower speed than the target speed, the low speed level may be defined as a speed corresponding to a 15% deceleration rate of the target speed, the normal speed level may be defined as a speed corresponding to a 10% deceleration rate of the target speed, and the high speed level may be defined as a speed corresponding to a 5% deceleration rate of the target speed. This is not limited to the above-described specific examples.

Referring back to FIG. 3, the processor 122 may detect whether the vehicle 100 reaches an area including an entry point of the roundabout and whether another vehicle travels in a section of the roundabout within a predetermined range from the entry point (S115).

Referring to FIG. 4, a route of the vehicle 100 that drives autonomously may include a roundabout including an entry point 510, a main lane section 530, and an exit point 550, a preceding road 520 connected to the entry point 510, and a following road connected to the exit point 550. The main lane section 530 may be a lane in which the vehicle is entering at the roundabout. In detail, the main lane section 530 may be a segment where the vehicle 100 travels along a circular trajectory within the roundabout. In further detail, the main lane section 530 may refer to a segment where the vehicle 100 introduced from the entry point 510 moves along a circular or curved trajectory before proceeding to the exit point 550. An area of the roundabout including the entry point 510 is an area which is present on the route, and as shown in FIG. 4, may include a portion of the preceding road 520 connected to the entry point 510, the entry point 510, and at least a portion of the main lane section 530 near to the entry point 510. The arrival of the area may be detected, for example, through a combination of surrounding environment data obtained from the sensor of the vehicle 100, the position data of the vehicle 100, and the map information. The surrounding environment data may include at least one of image data by a camera and LiDAR data, and the processor 122 may detect the arrival of the area based on the lane line shape, road sign/mark, etc. related to the entry point 510 of the roundabout of the surrounding environment data.

The processor 122 may be configured to determine whether another vehicle travels in a section of the roundabout within a predetermined range from the entry point in the area. Here, as shown in FIG. 4, the section of the roundabout may be a driving section of another vehicle 100 that causes an obstacle to the entry of a vehicle into the roundabout. The section may be at least a portion of the main lane section from the entry point. Depending on the size of the roundabout, the section may be a portion of the main lane section which is present at both sides of the entry point or the entirety of the main lane section. A portion of the main lane section may include a portion of the main lane section preceding the entry point 510 in a driving rotation direction of the roundabout and a portion of the main lane section following the entry point 510 in the driving rotation direction. Furthermore, the processor 122 may identify whether another vehicle 100 travels in the section of the roundabout that falls within the predetermined range, for example, based on the behavior of another vehicle 100 in the surrounding environment data and the behavior of another vehicle 100 obtained from communication with another vehicle 100 or an external device.

When another vehicle 100 travels in the section of the roundabout that falls within the predetermined range (Yes in S115), the processor 122 may perform a process of performing yield control of the vehicle 100 at the entry point (S120). The yield control may be performed so that the vehicle stops or decelerates at a stop line or yield line as shown in FIG. 4.

The yield control may be performed until no vehicle travels in the section of the roundabout in operation S115. For example, during deceleration for the yield control, when another preceding vehicle passes the roundabout, the vehicle 100 may stop the yield control.

When no vehicle 100 travels in the section of the roundabout within the above-mentioned predetermined range (No in S115), the processor 122 of the vehicle 100 may be configured to generate driving control information based on speed information and preceding vehicle information detected from a preceding vehicle that travels at the roundabout (S125).

The speed information may be provided in operation S110. Meanwhile, the processor 122 may identify another vehicle that travels in front of the vehicle 100 in the main lane section based on the surrounding environment data and data obtained from communication with another vehicle 100 or an external device. When the vehicle 100 travels in the main lane section, another vehicle may be a dynamic object which is expected to travel in front of the vehicle 100. When another preceding vehicle is expected, the processor 122 may be configured to generate behavior information related to another preceding vehicle based on the data. The preceding vehicle information may have, for example, a distance to another vehicle 100 in the main lane section, a speed of another vehicle 100, a driving trajectory of another vehicle 100, etc.

When another preceding vehicle is not expected and thus preceding vehicle information is not generated, the processor 122 may be configured to generate driving control information for autonomous movement at a roundabout based on speed information. The driving control information may include driving control related to entering and exiting the roundabout, driving in the main lane section, and a control plan of the operation indicator.

When another preceding vehicle is expected and thus preceding vehicle information is generated, the processor 122 may be configured to generate driving control information based on speed information and the preceding vehicle information. As described above, a basic driving speed of the roundabout may be determined by the speed information at the entry point and the driving in the main lane section. However, when a distance between vehicles based on the behavior of the preceding vehicle confirmed from the preceding vehicle information, that is, a speed that satisfies a safety distance from the preceding vehicle is lower than the speed information, the processor 122 may, for example, generate driving control information to follow a speed determined by distance control with the preceding vehicle. Due to the driving control information, the vehicle 100 may be controlled while securing a safety distance from the preceding vehicle during the entry into the roundabout and driving in the main lane section.

Next, the processor 122 may be configured for controlling the turn signal lamp for entering the roundabout to turn on and control the vehicle 100 to autonomously enter the roundabout according to the driving control information (S130).

The processor 122 may be configured for controlling the operation indicator 112 in an area including a place of the roundabout determined by the route of the vehicle 100. The area including the place of the roundabout may be an area related to the entry of the roundabout. As described in operation S115, the area related to the entry may include a portion of the preceding road connected to the entry point, the entry point, and a portion of the main lane section near to the entry point. As shown in FIG. 4, when the processor 122 detects the driving of the vehicle 100 on the preceding road 520 connected to the entry point 510 based on at least one of the surrounding environment data, the position information, and the map information, the processor 122 may be configured for controlling the operation indicator 112 to notify of the entry into the roundabout. Hereinafter, the operation indicator 112 is exemplified as a turn signal lamp, and the control of the turn signal lamp to turn on or off will be described with reference to FIG. 6. However, the present disclosure is not limited thereto, and other modules of the operation indicator 112 may also implement an operation related to the entry into the roundabout by the processor 122.

FIG. 6 is a flowchart of a process of controlling a turn signal lamp to turn on or off, which is implemented in an entry situation into a roundabout.

First, as shown in FIG. 4, the processor 122 may turn the turn signal lamp on before the entry point 510 of the roundabout (S205). Here, a time point before the entry point 510 may be a time point when the vehicle 100 travels on the preceding road 520 connected to the entry point 510.

Subsequently, the processor 122 may be configured to determine whether the vehicle 100 has behaved to satisfy entry completion conditions at the roundabout (S210). For example, the entry completion conditions may be satisfied by detecting that both rear wheels of the vehicle 100 enter the main lane section 530 of the roundabout. Position states of the rear wheels may be, for example, identified by at least one of estimated positions of the rear wheels obtained from a multi-camera sensor of the vehicle 100, a lane near to the entry point 510 detected by a camera sensor, and estimated positions of the rear wheels of the vehicle 100 that exchange with another vehicle. The entry completion conditions are referred to as the entry of both the rear wheels in an exemplary embodiment of the present disclosure, but are not limited thereto and may be defined in various ways.

When both the rear wheels of the vehicle 100 do not enter the main lane section and thus the entry completion conditions are not satisfied, the processor 122 may maintain turn-on of the turn signal lamp (S215).

On the other hand, when both the rear wheels enter and thus the entry completion conditions are satisfied, the processor 122 may turn the turn signal lamp off and control the autonomous driving of the vehicle 100 in the main lane section (S220).

By operations S215 and S220, the turn signal lamp may be activated up to an entry completion time point into the roundabout regardless of the user's manipulation of the turn signal lamp and a steering wheel torque value. Therefore, since the turn signal lamp is not turned off by the user's manipulation of the turn signal lamp and a steering torque, it is possible to ensure the operation and stability required for autonomous driving.

Referring back to FIG. 3, the processor 122 may be configured for controlling the vehicle 100 to autonomously enter from the preceding road 520 to the main lane section 530 according to the driving control information together with the control of the turn signal lamp to turn on or off.

Next, the processor 122 may be configured for controlling the autonomous driving of the vehicle in the main lane section of the roundabout according to the driving control information (S135). The driving control information may be based on the information generated in operation S125 and further include longitudinal control and transverse control that vary according to the behavior of another vehicle 100 in the main lane section and the trajectory of the vehicle 100 to the exit point. The longitudinal control may include a speed, acceleration, deceleration, etc. of the vehicle 100, and the transverse control may include steering control.

Next, the processor 122 may be configured for controlling the turn signal lamp for exiting the roundabout to turn on and control the vehicle 100 to autonomously exit the roundabout according to the driving control information (S140).

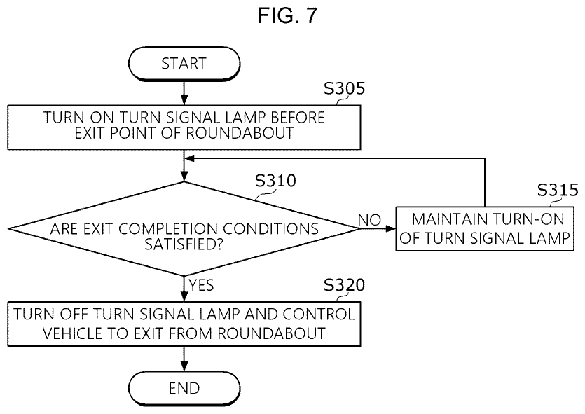

The processor 122 may be configured for controlling the operation indicator 112 in an area including a place of the roundabout determined by the route of the vehicle 100, that is, the exit point. As described in operation S115, the area related to exit may include a preceding section 560 of the main lane section connected to the exit point, an exit point 550, and a portion of a following road connected to the exit point as shown in FIG. 4. When the processor 122 detects the driving of the vehicle 100 in the preceding section 560 of the main lane section based on at least one of the surrounding environment data, the position information, and the map information, the processor 122 may be configured for controlling the operation indicator 112 to notify of the exit from the roundabout. Hereinafter, the operation indicator 112 is exemplified as a turn signal lamp, and the control of the turn signal lamp to turn on or off will be described with reference to FIG. 7. However, the present disclosure is not limited thereto, and other modules of the operation indicator 112 may also implement an operation related to the exit from the roundabout by the processor 122.

FIG. 7 is a flowchart of a process of controlling a turn signal lamp to turn on or off, which is implemented in a situation in which a vehicle exits a roundabout.

First, as shown in FIG. 4, the processor 122 may turn the turn signal lamp on before the exit point 550 of the roundabout (S305). Here, a time point before the exit point 550 may be a time point when the vehicle 100 travels on the preceding section 560 of the main lane section connected to the exit point 550.

Subsequently, the processor 122 may be configured to determine whether the vehicle 100 has behaved to satisfy exit completion conditions at the roundabout (S310). For example, the exit completion conditions may be satisfied by detecting that both rear wheels of the vehicle 100 exit the exit point 550. The position states of the rear wheels may be identified in substantially the same manner as the example of FIG. 6. The exit completion conditions are referred to as the exit of both the rear wheels in an exemplary embodiment of the present disclosure, but are not limited thereto, and may be defined in various ways.

When both the rear wheels of the vehicle 100 do not exit the exit point and thus the exit completion conditions are not satisfied, the processor 122 may maintain turn-on of the turn signal lamp (S315).

On the other hand, when both the rear wheels exit and thus the exit completion conditions are satisfied, the processor 122 may turn the turn signal lamp off and control the vehicle 100 to autonomously travel from the roundabout to the following road (S320).

By operations S315 and S320, the turn signal lamp may be activated up to an exit completion time point from the roundabout regardless of the user's manipulation of the turn signal lamp and a steering wheel torque value. Therefore, since the turn signal lamp is not turned off by the user's manipulation of the turn signal lamp and a steering torque, it is possible to ensure the operation and stability required for autonomous driving.

Referring back to FIG. 3, when the vehicle 100 exits the roundabout, the processor 122 may be configured for controlling the driving of the vehicle based on the target speed applied at the road which is subsequently connected to the roundabout (S145).

The present disclosure is directed to providing a method for controlling autonomous driving and a vehicle to prevent driving discomfort at a roundabout and improve stability by reflecting a user's driving pattern to control autonomous driving at the roundabout.

Furthermore, according to an exemplary embodiment of the present disclosure, it is possible to secure driving stability at a roundabout by achieving external notification of driving operations required for driving at the roundabout and driving control considering the behavior of other vehicles.

The effects obtainable from the present disclosure are not limited to the above-described effects, and other effects that are not described will be able to be clearly understood by those skilled in the art to which the present disclosure pertains from the following description.

While the exemplary methods of the present disclosure described above are represented as a series of operations for clarity of description, it is not intended to limit the order in which the steps are performed, and the steps may be performed simultaneously or in different order as necessary. To implement the method according to an exemplary embodiment of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

Furthermore, various embodiments of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

What is claimed is:

1. A method for controlling autonomous driving, the method comprising:
generating, by a processor, speed information for driving control of a vehicle at a roundabout based on driving setting information of a user related to the roundabout;
generating, by the processor, driving control information based on the speed information; and
controlling, by the processor, an operation indicator of the vehicle in an area including a place of the roundabout determined by a route of the vehicle and controlling, by the processor, a driving of the vehicle at the roundabout according to the driving control information,
wherein the driving setting information is generated in response to a mode selected from a designated mode and a driving pattern mode by the user.

2. The method of claim 1, wherein one of a required speed of the user at the roundabout and a first reduction level for a target speed of a road other than the roundabout is set in the designated mode, and a speed determined based on driving pattern information of the user at the roundabout is set in the driving pattern mode.

3. The method of claim 2, wherein the driving pattern information is provided based on driving data according to manual driving of the user at one or more roundabouts or past driving setting information of the user, and a reference number or more of pieces of the driving data is accumulated and collected as data for the driving at a speed limit or less at the roundabout.

4. The method of claim 2, wherein a speed according to a second reduction level of the target speed determined based on the driving pattern information is set in the driving pattern mode, and a reduction ratio for the target speed applied to the second reduction level is provided differently from a reduction ratio of the target speed at the first reduction level.

5. The method of claim 1, wherein the generating of the speed information comprises generating the speed information based on driving route information of the vehicle, a target speed of a driving road before entering the roundabout, and a speed limit at the roundabout in addition to the driving setting information.

6. The method of claim 1, further comprising, before the controlling of the operation indicator and the controlling of the driving,
performing yield control of the vehicle at an entry point based on that the vehicle reaches an area including the entry point of the roundabout and detecting that another vehicle travels in a section of the roundabout that falls within a predetermined range from the entry point.

7. The method of claim 1, wherein the generating of the driving control information comprises generating the driving control information based on preceding vehicle information detected from a preceding vehicle that travels at the roundabout in addition to the speed information.

8. The method of claim 1,
wherein the operation indicator includes a turn signal lamp, and
wherein the controlling of the operation indicator of the vehicle includes:
turning the turn signal lamp on before an entry point of the roundabout; and
turning the turn signal lamp off in response to detection that both rear wheels of the vehicle enter a main lane section of the roundabout, the main lane section being a lane in which the vehicle is entering at the roundabout.

9. The method of claim 1,
wherein the operation indicator includes a turn signal lamp, and
wherein the controlling of the operation indicator of the vehicle includes:
turning the turn signal lamp on before an exit point of the roundabout; and
turning the turn signal lamp off in response to detection that both rear wheels of the vehicle exit the exit point.

10. The method of claim 1, further comprising, after the controlling of the operation indicator and the controlling of the driving,
controlling the driving of the vehicle based on a target speed applied at a road subsequently connected to the roundabout in response to exit of the vehicle from the roundabout.

11. A vehicle comprising:
a sensor unit configured to detect a surrounding environment of the vehicle;
a memory configured to store at least one instruction controlling the vehicle; and
a processor operatively connected to the sensor unit and the memory and configured to execute the at least one instruction stored in the memory,
wherein the processor is configured to:
generate speed information for driving control of the vehicle at a roundabout based on driving setting information of a user related to the roundabout;
generate driving control information based on the speed information; and
control an operation indicator of the vehicle in an area including a place of the roundabout determined by a route of the vehicle and control a driving of the vehicle at the roundabout according to the driving control information, and
wherein the driving setting information is generated in response to a mode selected from a designated mode and a driving pattern mode by the user.

12. The vehicle of claim 11, wherein one of a required speed of the user at the roundabout and a first reduction level for a target speed of a road other than the roundabout is set in the designated mode, and a speed determined based on driving pattern information of the user at the roundabout is set in the driving pattern mode.

13. The vehicle of claim 12, wherein the driving pattern information is provided based on driving data according to manual driving of the user at one or more roundabouts or past driving setting information of the user, and a reference number or more of pieces of the driving data is accumulated and collected as data for the driving at a speed limit or less at the roundabout.

14. The vehicle of claim 12, wherein a speed according to a second reduction level of the target speed determined based on the driving pattern information is set in the driving pattern mode, and a reduction ratio for the target speed applied to the second reduction level is provided differently from a reduction ratio of the target speed at the first reduction level.

15. The vehicle of claim 11, wherein the generating of the speed information comprises generating the speed information based on driving route information of the vehicle, a target speed of a driving road before entering the roundabout, and a speed limit at the roundabout in addition to the driving setting information.

16. The vehicle of claim 11, wherein, before the controlling of the operation indicator and the driving, the processor is further configured to perform yield control of the vehicle at an entry point based on that the vehicle reaches an area including the entry point of the roundabout and to detect that another vehicle travels in a section of the roundabout that falls within a predetermined range from the entry point.

17. The vehicle of claim 11, wherein the generating of the driving control information comprises generating the driving control information based on preceding vehicle information detected from a preceding vehicle that travels at the roundabout in addition to the speed information.

18. The vehicle of claim 11,
wherein the operation indicator includes a turn signal lamp, and
wherein the controlling of the operation indicator of the vehicle includes:
turning the turn signal lamp on before an entry point of the roundabout; and
turning the turn signal lamp off in response to detection that both rear wheels of the vehicle enter a main lane section of the roundabout, the main lane section being a lane in which the vehicle is entering at the roundabout.

19. The vehicle of claim 11,
wherein the operation indicator includes a turn signal lamp, and
wherein the controlling of the operation indicator of the vehicle includes:
turning the turn signal lamp on before an exit point of the roundabout; and
turning the turn signal lamp off in response to detection that both rear wheels of the vehicle exit the exit point.

20. The vehicle of claim 11, wherein, after the controlling of the operation indicator and the driving, the processor is further configured to control the driving of the vehicle based on a target speed applied at a road subsequently connected to the roundabout in response to exit of the vehicle from the roundabout.
